(19) United States
(12) Patent Application Publication
(10) Pub. No.: US 2013/0195086 A1
(43) Pub. Date: Aug. 1, 2013

(54) TIMING MANAGEMENT IN UPLINK (UL) COORDINATED MULTIPOINT (COMP) TRANSMISSION

(71) Applicant: QUALCOMM Incorporated, San Diego, CA (US)

(72) Inventors: Hao Xu, San Diego, CA (US); Peter Gaal, San Diego, CA (US); Wanshi Chen, San Diego, CA (US); Yongbin Wei, San Diego, CA (US)

(73) Assignee: QUALCOMM INCORPORATED, San Diego, CA (US)

(21) Appl. No.: 13/755,382

(22) Filed: Jan. 31, 2013

Related U.S. Application Data
(60) Provisional application No. 61/593,649, filed on Feb. 1, 2012.

(51) Int. Cl. H04W 72/04

(52) U.S. Cl. CPC H04W 72/04
USPC 370/336

(57) ABSTRACT

According to example embodiments, a method for wireless communications by a user equipment (UE) includes receiving signaling indicating multiple timing adjustments (TAs) for different uplink channels between the user equipment (UE) and one or more transmission points, and applying at least one of the multiple TAs when transmitting on at least one of the uplink channels. According to example embodiments, a method for wireless communications by a base station includes determining multiple timing adjustments (TAs) for different uplink channels between the user equipment (UE) and one or more transmission points, and transmitting signaling indicating the multiple timing adjustments (TAs) to the UE.

### CLAIM OF PRIORITY UNDER 35 U.S.C. §119

This application claims benefit of U.S. Provisional Patent Application No. 61/593,649, filed Feb. 1, 2012, which is herein incorporated by reference in its entirety.

### BACKGROUND

I. Field

Certain aspects of the disclosure generally relate to wireless communications and, more particularly, to techniques for managing timing in uplink (UL) coordinated multipoint (CoMP) transmissions.

II. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may observe interference due to transmissions from neighbor base stations. On the uplink, a transmission from the UE may cause interference to transmissions from other UEs communicating with the neighbor base stations. The interference may degrade performance on both the downlink and uplink.

### SUMMARY

Certain aspects of the present disclosure provide techniques, corresponding apparatus, and program products, for timing management in a coordinated multipoint (CoMP) system.

Certain aspects provide a method for wireless communications by a user equipment (UE). The method generally includes receiving signaling indicating multiple timing adjustments (TAs) for different uplink channels between the user equipment (UE) and one or more transmission points, and applying at least one of the multiple TAs when transmitting on at least one of the uplink channels.

Certain aspects provide a method for wireless communications by a base station (e.g., eNB or other type transmission point). The method generally includes determining multiple timing adjustments (TAs) for different uplink channels between the user equipment (UE) and one or more transmission points, and transmitting signaling indicating the multiple timing adjustments (TAs) to the UE.

Certain aspects of the present disclosure provide an apparatus for wireless communications. The apparatus generally includes means for receiving signaling indicating multiple timing adjustments (TAs) for different uplink channels between the user equipment (UE) and one or more transmission points, and means for applying at least one of the multiple TAs when transmitting on at least one of the uplink channels.

Certain aspects of the present disclosure provide an apparatus for wireless communications. The apparatus generally includes means for determining multiple timing adjustments (TAs) for different uplink channels between the user equipment (UE) and one or more transmission points, and means for transmitting signaling indicating the multiple timing adjustments (TAs) to the UE.

Certain aspects of the present disclosure provide an apparatus for wireless communications. The apparatus generally includes at least one processor and a memory coupled with the at least one processor. The processor is generally configured to receive signaling indicating multiple timing adjustments (TAs) for different uplink channels between the user equipment (UE) and one or more transmission points, and apply at least one of the multiple TAs when transmitting on at least one of the uplink channels.

Certain aspects of the present disclosure provide an apparatus for wireless communication. The apparatus generally includes at least one processor and a memory coupled with the at least one processor. The processor is generally configured to determine multiple timing adjustments (TAs) for different uplink channels between the user equipment (UE) and one or more transmission points, and transmit signaling indicating the multiple timing adjustments (TAs) to the UE.

Certain aspects of the present disclosure provide a computer-program product for wireless communications. The computer-program product generally includes a computer-readable medium having code for receiving signaling indicating multiple timing adjustments (TAs) for different uplink channels between the user equipment (UE) and one or more transmission points, and applying at least one of the multiple TAs when transmitting on at least one of the uplink channels.

Certain aspects of the present disclosure provide a computer-program product for wireless communications. The computer-program product generally includes a computer-readable medium having code for determining multiple timing adjustments (TAs) for different uplink channels between the user equipment (UE) and one or more transmission points, and transmitting signaling indicating the multiple timing adjustments (TAs) to the UE.

Various aspects and features of the disclosure are described in further detail below.

### BRIEF DESCRIPTION OF THE DRAWINGS

FIG. 1 is a block diagram conceptually illustrating an example of a wireless communications network in accordance with certain aspects of the present disclosure.

FIG. 2 is a block diagram conceptually illustrating an example of a frame structure in a wireless communications network, in accordance with certain aspects of the present disclosure.

FIG. 2A shows an example format for the uplink in Long Term Evolution (LTE), in accordance with certain aspects of the present disclosure.

FIG. 3 shows a block diagram conceptually illustrating an example of a Node B in communication with a user equipment device (UE) in a wireless communications network, in accordance with certain aspects of the present disclosure.

FIG. 4 illustrates an example heterogeneous network (HetNet), in accordance with certain aspects of the present disclosure.

FIG. 5 illustrates example resource partitioning in a heterogeneous network, in accordance with certain aspects of the present disclosure.

FIG. 6 illustrates example cooperative partitioning of subframes in a heterogeneous network, in accordance with certain aspects of the present disclosure.

FIG. 7 illustrates an example scenario of a Coordinated MultiPoint (CoMP) transmission, in accordance with certain aspects of the present disclosure.

FIG. 8 illustrates another example scenario of a Coordinated MultiPoint (CoMP) transmission, in accordance with certain aspects of the present disclosure.

FIG. 9 illustrates example operations that may be performed by a user equipment (UE), in accordance with aspects of the present disclosure.

FIG. 10 illustrates example operations that may be performed, for example, by a base station, in accordance with aspects of the present disclosure.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

### Example Wireless Network

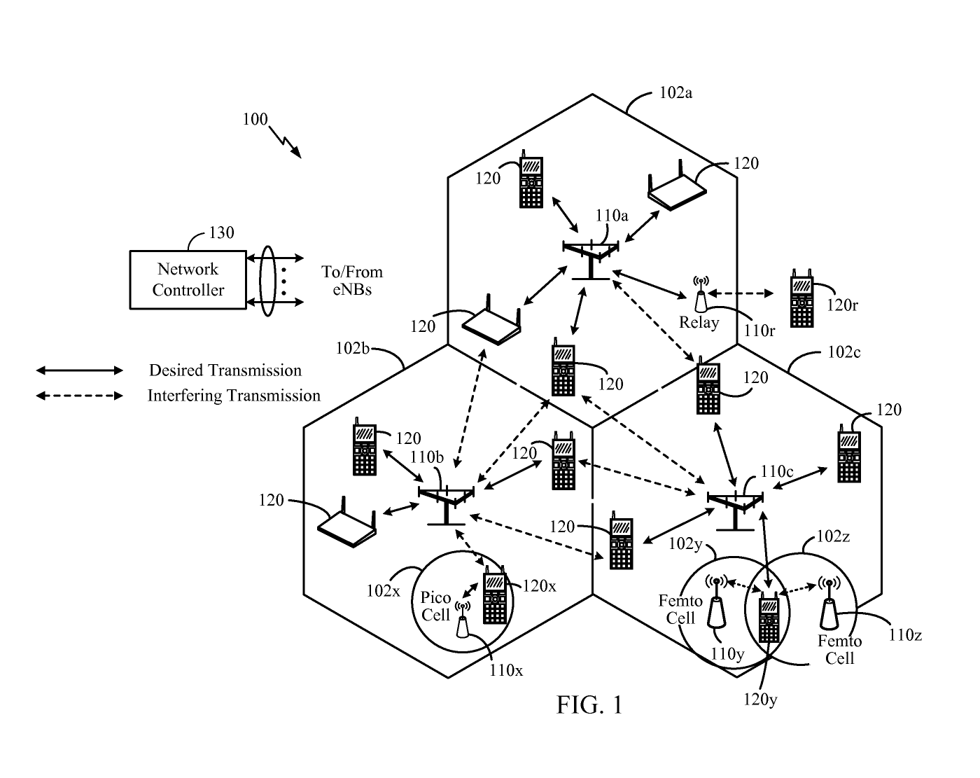

FIG. 1 shows a wireless communication network 100, which may be an LTE network. The wireless network 100 may include a number of evolved Node Bs (eNBs) 110 and other network entities. An eNB may be a station that communicates with user equipment devices (UEs) and may also be referred to as a base station, a Node B, an access point, etc. Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB (i.e., a macro base station). An eNB for a pico cell may be referred to as a pico eNB (i.e., a pico base station). An eNB for a femto cell may be referred to as a femto eNB (i.e., a femto base station) or a home eNB. In the example shown in FIG. 1, eNBs 110a, 110b, and 110c may be macro eNBs for macro cells 102a, 102b, and 102c, respectively. eNB 110x may be a pico eNB for a pico cell 102x. eNBs 110y and 110z may be femto eNBs for femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with eNB 110a and a UE 120r in order to facilitate communication between eNB 110a and UE 120r. A relay station may also be referred to as a relay eNB, a relay, etc.

The wireless network 100 may be a heterogeneous network (HetNet) that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 watts) whereas pico eNBs, femto eNBs, and relays may have a lower transmit power level (e.g., 1 watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a tablet, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB. For certain aspects, the UE may comprise an LTE Release 10 UE.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz, and there may be 1, 2, 4, 8, or 16 subbands for system bandwidth of 1.25, 2.5, 5, 10, or 20 MHz, respectively.

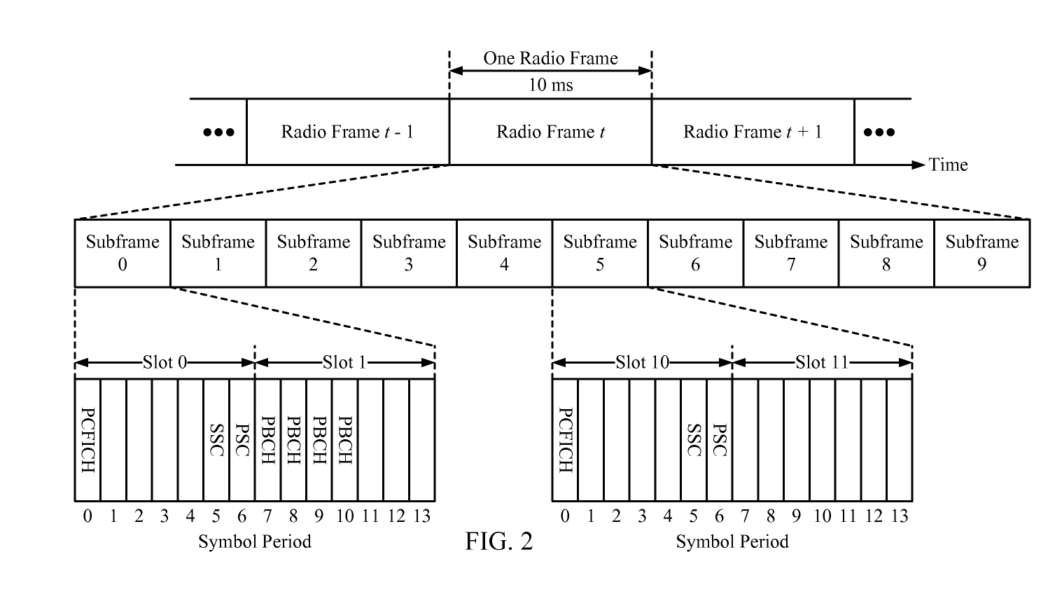

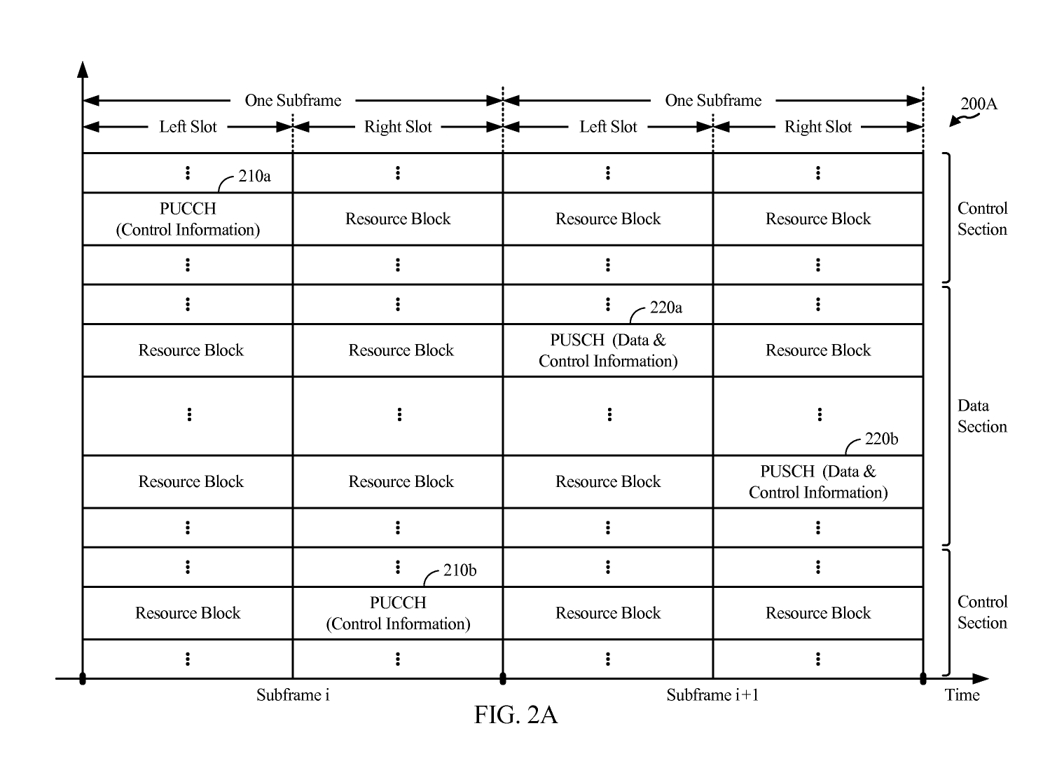

FIG. 2 shows a frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., L=7 symbol periods for a normal cyclic prefix (as shown in FIG. 2) or L=6 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as shown in FIG. 2. The PCFICH may convey the number of symbol periods (M) used for control channels, where M may be equal to 1, 2, or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe (not shown in FIG. 2). The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 32, or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

FIG. 2A shows an exemplary format 200A for the uplink in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 2A results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNB. The UE may transmit control information in a Physical Uplink Control Channel (PUCCH) 210a, 210b on the assigned resource blocks in the control section. The UE may transmit only data or both data and control information in a Physical Uplink Shared Channel (PUSCH) 220a, 220b on the assigned resource blocks in the data section. An uplink transmission may span both slots of a subframe and may hop across frequency as shown in FIG. 2A.

A UE may be within the coverage of multiple eNBs. One of these eNBs may be selected to serve the UE. The serving eNB may be selected based on various criteria such as received power, pathloss, signal-to-noise ratio (SNR), etc.

A UE may operate in a dominant interference scenario in which the UE may observe high interference from one or more interfering eNBs. A dominant interference scenario may occur due to restricted association. For example, in FIG. 1, UE 120y may be close to femto eNB 110y and may have high received power for eNB 110y. However, UE 120y may not be able to access femto eNB 110y due to restricted association and may then connect to macro eNB 110c with lower received power (as shown in FIG. 1) or to femto eNB 110z also with lower received power (not shown in FIG. 1). UE 120y may then observe high interference from femto eNB 110y on the downlink and may also cause high interference to eNB 110y on the uplink.

A dominant interference scenario may also occur due to range extension, which is a scenario in which a UE connects to an eNB with lower pathloss and lower SNR among all eNBs detected by the UE. For example, in FIG. 1, UE 120x may detect macro eNB 110b and pico eNB 110x and may have lower received power for eNB 110x than eNB 110b. Nevertheless, it may be desirable for UE 120x to connect to pico eNB 110x if the pathloss for eNB 110x is lower than the pathloss for macro eNB 110b. This may result in less interference to the wireless network for a given data rate for UE 120x.

In an aspect, communication in a dominant interference scenario may be supported by having different eNBs operate on different frequency bands. A frequency band is a range of frequencies that may be used for communication and may be given by (i) a center frequency and a bandwidth or (ii) a lower frequency and an upper frequency. A frequency band may also be referred to as a band, a frequency channel, etc. The frequency bands for different eNBs may be selected such that a UE can communicate with a weaker eNB in a dominant interference scenario while allowing a strong eNB to communicate with its UEs. An eNB may be classified as a “weak” eNB or a “strong” eNB based on the received power of signals from the eNB received at a UE (and not based on the transmit power level of the eNB).

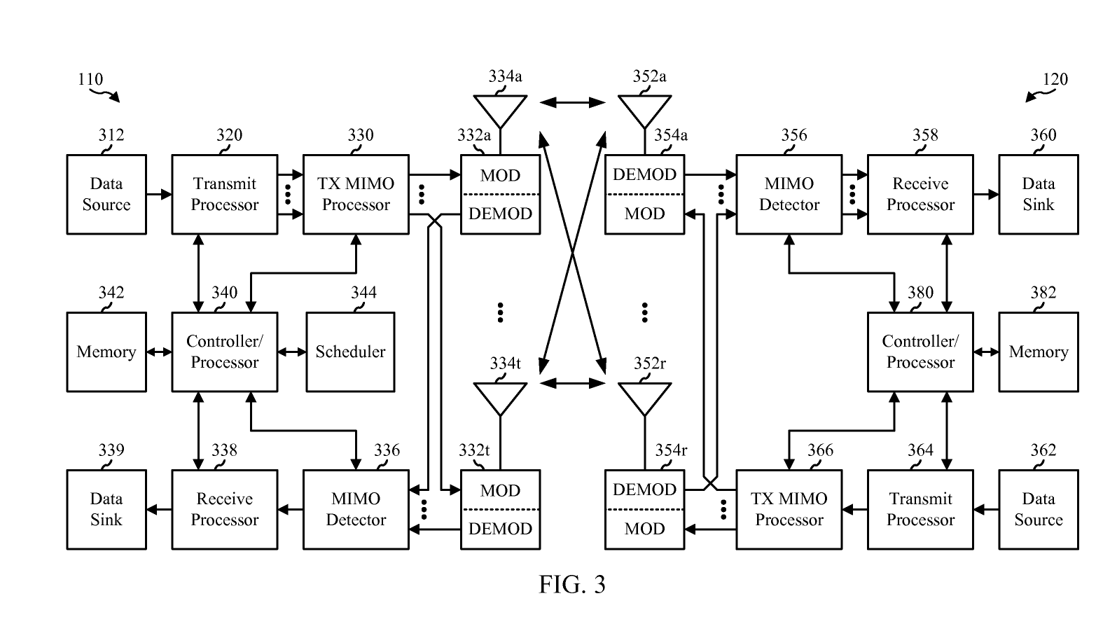

FIG. 3 is a block diagram of a design of a base station or an eNB 110 and a UE 120, which may be one of the base stations/eNBs and one of the UEs in FIG. 1. For a restricted association scenario, the eNB 110 may be macro eNB 110c in FIG. 1, and the UE 120 may be UE 120y. The eNB 110 may also be a base station of some other type. The eNB 110 may be equipped with T antennas 334a through 334t, and the UE 120 may be equipped with R antennas 352a through 352r, where in general T≧1 and R≧1.

At the eNB 110, a transmit processor 320 may receive data from a data source 312 and control information from a controller/processor 340. The control information may be for the PBCH, PCFICH, PHICH, PDCCH, etc. The data may be for the PDSCH, etc. The transmit processor 320 may process (e.g., encode and symbol map) the data and control information to obtain data symbols and control symbols, respectively. The transmit processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide T output symbol streams to T modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively.

At the UE 120, antennas 352a through 352r may receive the downlink signals from the eNB 110 and may provide received signals to demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all R demodulators 354a through 354r, perform MIMO detection on the received symbols, if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from transmit processor 364 may be precoded by a TX MIMO processor 366 if applicable, further processed by modulators 354a through 354r (e.g., for SC-FDM, etc.), and transmitted to the eNB 110.

At the eNB 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

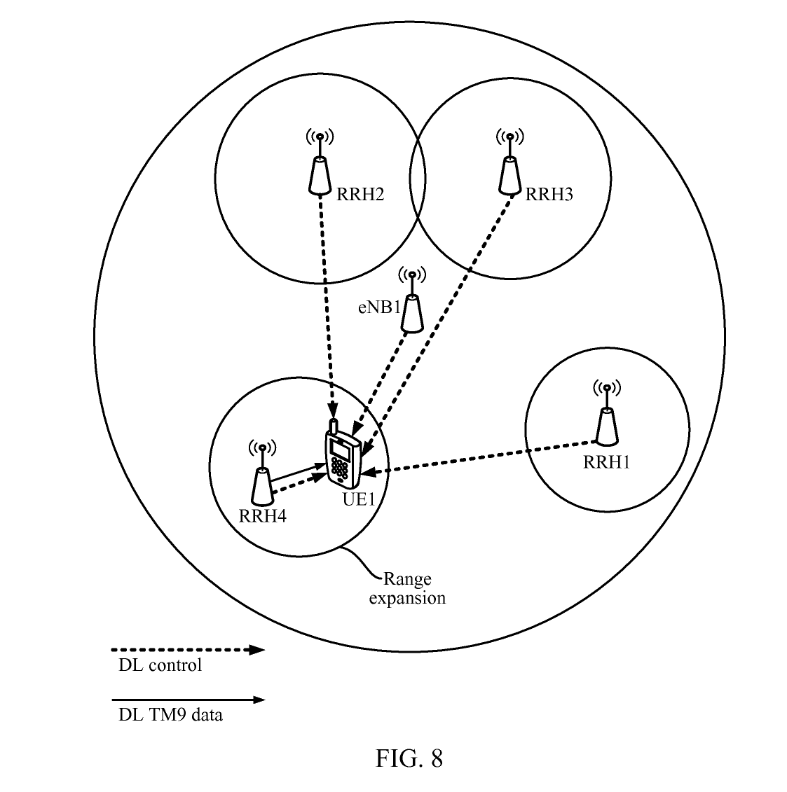

The controllers/processors 340 and 380 may direct the operation at the eNB 110 and the UE 120, respectively. The controller/processor 340, receive processor 338, and/or other processors and modules at the eNB 110 may perform or direct operations 800 in FIG. 8 and/or other processes for the techniques described herein. The memories 342 and 382 may store data and program codes for the eNB 110 and the UE 120, respectively. A scheduler 344 may schedule UEs for data transmission on the downlink and/or uplink.

### Example Resource Partitioning

According to certain aspects of the present disclosure, when a network supports enhanced inter-cell interference coordination (eICIC), the base stations may negotiate with each other to coordinate resources in order to reduce or eliminate interference by the interfering cell giving up part of its resources. In accordance with this interference coordination, a UE may be able to access a serving cell even with severe interference by using resources yielded by the interfering cell.

For example, a femto cell with a closed access mode (i.e., in which only a member femto UE can access the cell) in the coverage area of an open macro cell may be able to create a “coverage hole” (in the femto cell's coverage area) for a macro cell by yielding resources and effectively removing interference. By negotiating for a femto cell to yield resources, the macro UE under the femto cell coverage area may still be able to access the UE's serving macro cell using these yielded resources.

In a radio access system using OFDM, such as Evolved Universal Terrestrial Radio Access Network (E-UTRAN), the yielded resources may be time based, frequency based, or a combination of both. When the coordinated resource partitioning is time based, the interfering cell may simply not use some of the subframes in the time domain. When the coordinated resource partitioning is frequency based, the interfering cell may yield subcarriers in the frequency domain. With a combination of both frequency and time, the interfering cell may yield frequency and time resources.

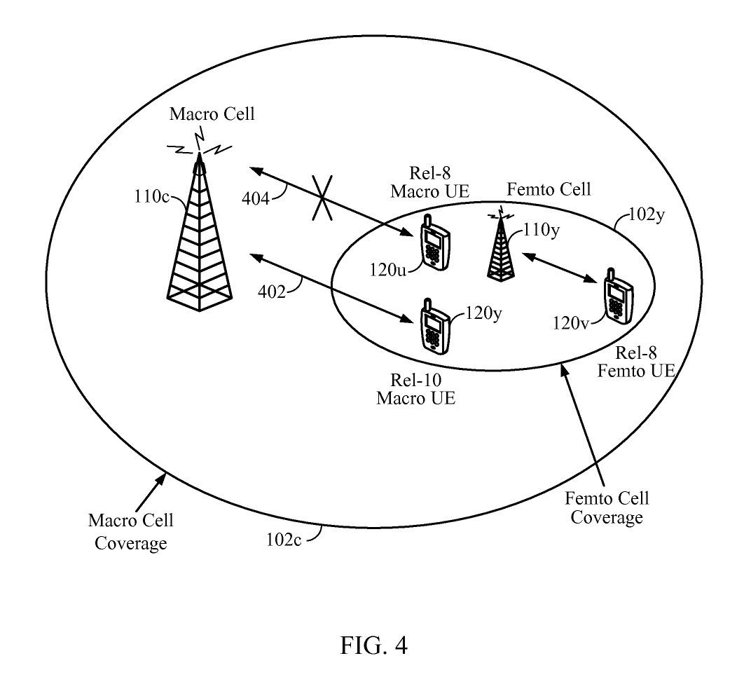

FIG. 4 illustrates an example scenario where eICIC may allow a macro UE 120y supporting eICIC (e.g., a Rel-10 macro UE as shown in FIG. 4) to access the macro cell 110c even when the macro UE 120y is experiencing severe interference from the femto cell y, as illustrated by the solid radio link 402. A legacy macro UE 120u (e.g., a Rel-8 macro UE as shown in FIG. 4) may not be able to access the macro cell 110c under severe interference from the femto cell 110y, as illustrated by the broken radio link 404. A femto UE 120v (e.g., a Rel-8 femto UE as shown in FIG. 4) may access the femto cell 110y without any interference problems from the macro cell 110c.

According to certain aspects, networks may support eICIC, where there may be different sets of partitioning information. A first of these sets may be referred to as Semi-static Resource Partitioning Information (SRPI). A second of these sets may be referred to as Adaptive Resource Partitioning Information (ARPI). As the name implies, SRPI typically does not change frequently, and SRPI may be sent to a UE so that the UE can use the resource partitioning information for the UE's own operations.

As an example, the resource partitioning may be implemented with 8 ms periodicity (8 subframes) or 40 ms periodicity (40 subframes). According to certain aspects, it may be assumed that frequency division duplexing (FDD) may also be applied such that frequency resources may also be partitioned. For communications via the downlink (e.g., from a cell node B to a UE), a partitioning pattern may be mapped to a known subframe (e.g., a first subframe of each radio frame that has a system frame number (SFN) value that is a multiple of an integer N, such as 4). Such a mapping may be applied in order to determine resource partitioning information (RPI) for a specific subframe. As an example, a subframe that is subject to coordinated resource partitioning (e.g., yielded by an interfering cell) for the downlink may be identified by an index:

Index_{SRPI}_{_{—}}_{DL}=(SFN*10+subframe number)mod 8

For the uplink, the SRPI mapping may be shifted, for example, by 4 ms. Thus, an example for the uplink may be:

Index_{SRPI}_{_{—}}_{UL}=(SFN*10+subframe number+4)mod 8

SRPI may use the following three values for each entry:
U (Use): this value indicates the subframe has been cleaned up from the dominant interference to be used by this cell (i.e., the main interfering cells do not use this subframe);
N (No Use): this value indicates the subframe shall not be used; and
X (Unknown): this value indicates the subframe is not statically partitioned. Details of resource usage negotiation between base stations are not known to the UE.

Another possible set of parameters for SRPI may be the following:
U (Use): this value indicates the subframe has been cleaned up from the dominant interference to be used by this cell (i.e., the main interfering cells do not use this subframe);
N (No Use): this value indicates the subframe shall not be used;
X (Unknown): this value indicates the subframe is not statically partitioned (and details of resource usage negotiation between base stations are not known to the UE); and
C (Common): this value may indicate all cells may use this subframe without resource partitioning. This subframe may be subject to interference, so that the base station may choose to use this subframe only for a UE that is not experiencing severe interference.

The serving cell's SRPI may be broadcasted over the air. In E-UTRAN, the SRPI of the serving cell may be sent in a master information block (MIB), or one of the system information blocks (SIBs). A predefined SRPI may be defined based on the characteristics of cells, e.g. macro cell, pico cell (with open access), and femto cell (with closed access). In such a case, encoding of SRPI in the system overhead message may result in more efficient broadcasting over the air.

The base station may also broadcast the neighbor cell's SRPI in one of the SIBs. For this, SRPI may be sent with its corresponding range of physical cell identities (PCIs).

ARPI may represent further resource partitioning information with the detailed information for the ‘X’ subframes in SRPI. As noted above, detailed information for the ‘X’ subframes is typically only known to the base stations, and a UE does not know it.

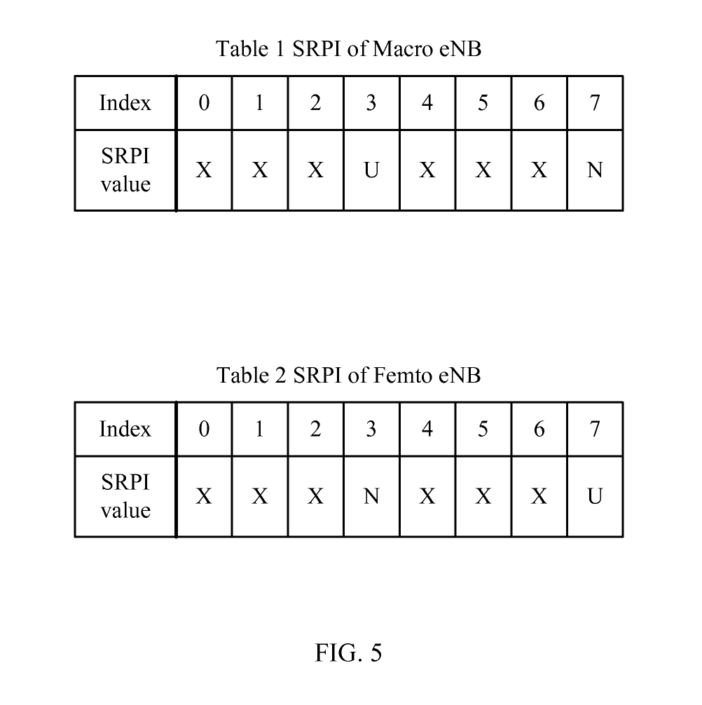

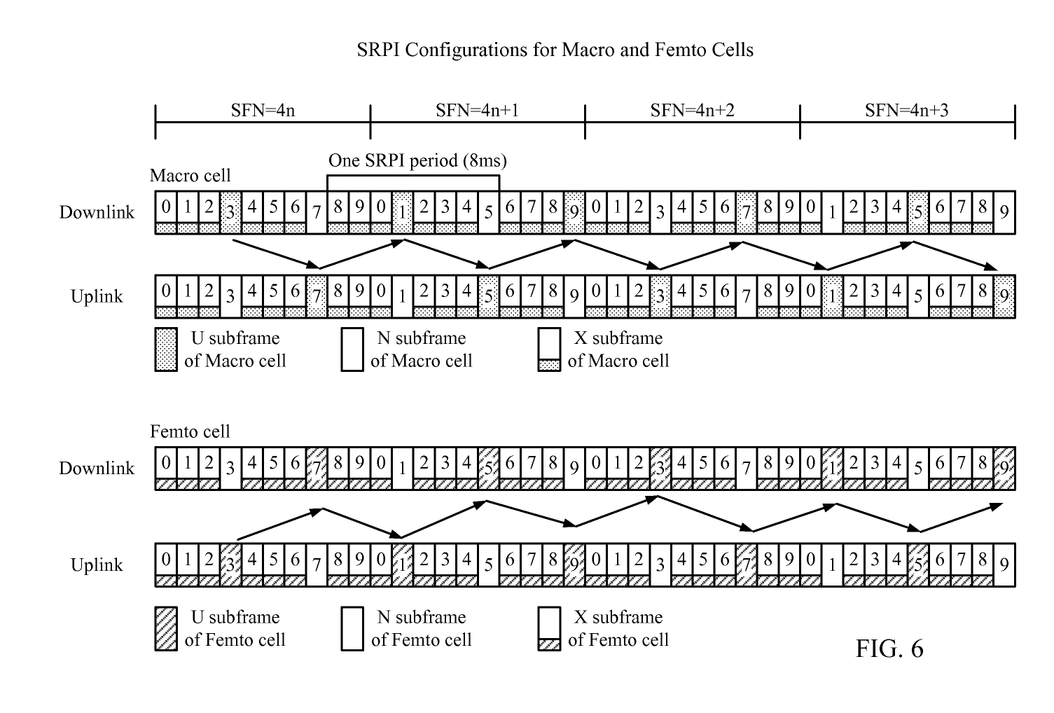

FIGS. 5 and 6 illustrate examples of SRPI assignment in the scenario with macro and femto cells. A U, N, X, or C subframe is a subframe corresponding to a U, N, X, or C SRPI assignment.

### Uplink Comp—Timing Management

Aspects of the present disclosure provide techniques for adjusting timing of uplink transmissions where different timing may be applied to different channels, for example, when the different uplink channels are intended to be received by different receiving entities involved in a coordinated multipoint (CoMP) operations.

A variety of scenarios may be considered in which timing management with respect to CoMP may be performed in different manners, four of which are described below. A first scenario may be referred to as CoMP “Scenario-1” directed to a homogeneous network including intra-site CoMP. A second scenario is referred to as CoMP “Scenario-2” directed to a homogeneous network including fiber connected high power nodes.

A third scenario is referred to as CoMP “Scenario-3” in which transmission points have different cell-IDs. In this scenario, a UE may receive control information from a transmission point that is different from the transmission point of data. For example, control information may be received on legacy PDCCH from a macro-cell and data may be received from Remote Radio Heads (RRHs). Also, “Scenario-3” may include high power macro-cells with low power RRHs.

A fourth scenario is referred to as CoMP “Scenario-4” in which transmission points share the same cell-ID. Consequently, control information transmitted via the PDCCH is common to all points in the CoMP cluster. Also, “Scenario-4” may include high power macro-cells with low power RRHs.

An eNB typically transmits Timing Advance (TA) command(s) (also referred to as Timing Adjustment command(s)) to the UE such that signals from different UEs arrive at the eNB at relatively the same time. If the signals arrive at the eNB at different times, it may be relatively difficult to maintain orthogonality. In UL CoMP, if a UE switches from cell to different cell, the UE may have to change timing for each different cell, since each cell may have its own timing.

Thus, there may be a situation where it is desirable to switch timing for different cells. In UL CoMP, if the UE switches the UL receiving cell, it is possible to have different TA values to align to different cells. This may present various timing issues, as described below.

For UL CoMP, Physical Uplink Shared CHannel (PUSCH) and Physical Uplink Control CHannel (PUCCH) can be received by one cell or multiple cells. The receiving cell/cells for PUSCH/PUCCH are typically determined by the minimum path loss association to achieve, for example, link budget efficiency. Therefore, it may be desirable to always transmit to a cell that is the closest. However, a Sounding Reference Signal (SRS) channel—which is used to sound the channel to provide the channel quality to the eNB—may have completely different receiving cell requirements. SRS is the main channel that facilitates DL/UL reciprocity, UL-assisted CoMP association, proximity detection, etc. Therefore, the SRS reception points, in many cases, are different from other PUSCH/PUCCH channels in CoMP and the TA for SRS can be different from the TA for PUSCH/PUCCH.

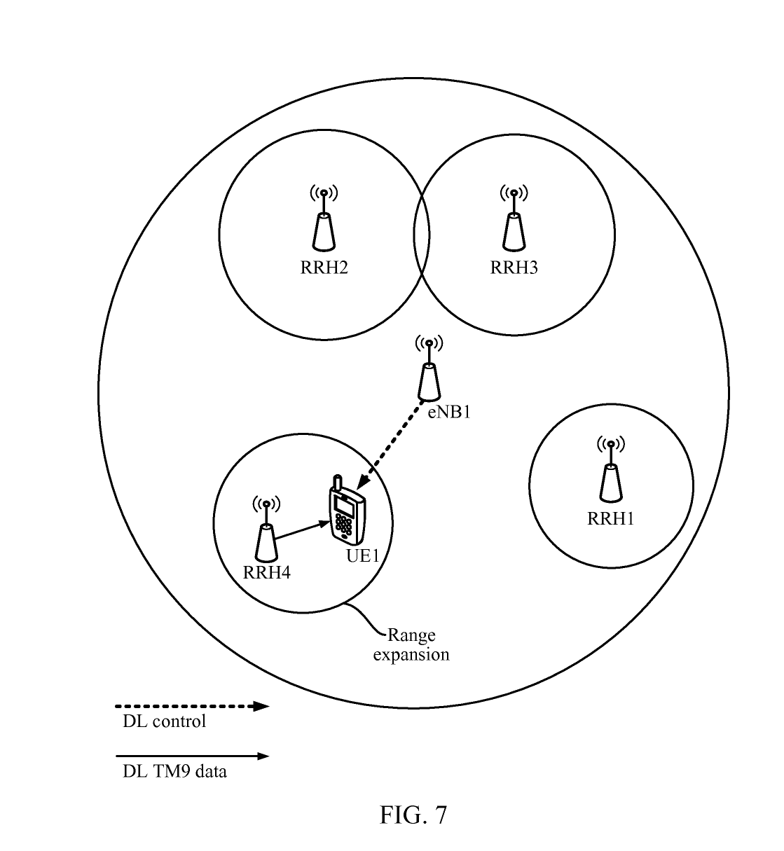

FIG. 7 illustrates an example scenario of a CoMP transmission, in accordance with certain aspects of the present disclosure. As seen in FIG. 7, in the UL, the UE 1 is much closer to RRH4 and may transmit data and/or control to RRH4. It may therefore be desirable for UE 1 to be served by RRH 4 on the uplink. In this case, UE 1 would measure the path loss on the DL from eNB 1 and apply transmit power to RRH4. But the SRS may be intended to sound the channel to other nodes, for example, eNB1, RRH1-3. This is because eNB1, RRH1-3 are participating in the downlink (DL) CoMP. Therefore, the SRS and PUSCH and/or PUCCH may be intended for different cells and thus have different TA requirements.

In some embodiments, where SRS and PUSCH and/or PUCCH have different TA requirements, within a common subframe, PUSCH and PUCCH may have one TA command and SRS may have a different TA command or different TA values. This presents a conflict.

In time division duplex (TDD) systems, the SRS channel is used to determine a DL CoMP set. In this case, the UL receiving cells are the cells in the DL CoMP set instead of UL CoMP set. For frequency division duplex (FDD) systems, it is possible to use the SRS channel to sound a larger set of participating cells, while PUSCH and PUCCH channels are received by a different set of cells (e.g. the closest cell). This leads to different requirement of TA for different channels.

The current LTE standard does not consider different TAs for different UL channels.

FIG. 8 illustrates another example scenario of a Coordinated MultiPoint (CoMP) transmission, in accordance with certain aspects of the present disclosure. As seen in FIG. 8, downlink (DL) signal is transmitted from one macro cell and four picocells, but the uplink (UL) transmission may use only RRH 4, since RRH 4 is closer to the UE1. The receive side may have downlink (DL) and uplink (UL) from all cells, but data (PUSCH/PUCCH) will be received by RRH4 and SRS will be received by all the cells including RRH4. As such, the reception point for PUSCH/PUCCH and SRS are different. SRS is required to sound the channel to other cells to determine the best DL association or proximity to other nodes.

The present disclosure provides techniques that may help address these issues. These techniques, for example, include using different TAs for different UL channels. Herein, the eNB may signal to the UE different TA commands for different channels for different cells. For example, the UE may be signaled TA1 for PUSCH/PUCCH transmission to cell 1, TA2 for PUSCH/PUCCH transmission to cell 2 and TA3 for SRS transmission targeted to some other cell/cells. Accordingly, the solution provides multiple different TA's for multiple different cells and also multiple different TA's for multiple different channels for a same user. For example, the UE applies TA1 for PUSCH/PUCCH when it is transmitting to cell 1 and UE applies TA2 for PUSCH/PUCCH when it is transmitting to cell 2.

For SRS transmissions, various techniques may be utilized. In a first option “Option 1,” SRS timing is aligned with PUSCH/PUCCH—the transmission may follow SRS timing or PUSCH/PUCH timing. Herein, the UE receives all the TA commands. Within a subframe, the UE has 2 channels to send PUSCH and PUCCH along with SRS. The PUSCH/PUCCH may be transmitted with PUSCH/PUCCH timing or using the SRS timing. The timing determination is described below. The TA is never changed within the same subframe. PUSCH applies TA1 for cell 1 and TA2 for cell 2. If SRS is transmitted on the same subframe with PUSCH, the SRS will follow PUSCH's TA command. SRS's own TA command is overwritten by PUSCH TA when they are transmitted together.

In some embodiments, the PUSCH/PUCCH and SRS may have different virtual cell ID, even though they are transmitted from the same UE. For example, a first transmission may include PUSCH TA1 and SRS TA1 to cell 1, a second transmission may include PUSCH TA2 and SRS TA2 to cell 2 and a third transmission may include SRS's own TA is overwritten by PUSCH's TA when they are transmitted together. As is seen, in the third case, the SRS is transmitted with TA3 as mentioned above, but when SRS is transmitted with PUSCH, the TA3 of SRS is not used. In this case, the transmission rule is such that the PUSCH timing will have priority over the SRS timing, and PUSCH/PUCCH will have the timing alignment at eNB. Overwriting SRS TA by the PUSCH/PUCCH TA, whenever it is transmitted within the same subframe with the PUSCH/PUCCH, by way of, for example, Layer 3 (L3) signaling is not disclosed in the standard as of this writing.

An alternative solution (e.g., logically opposite) is that PUSCH timing will follow SRS timing, in such a case, SRS channel will maintain the timing alignment at the receiving eNB. Again, whenever there is difference between the TA for SRS and PUSCH, the current standard does not specify whether PUSCH will overwrite its own TA based on the SRS TA, for example, based on Layer 3 (L3) signaling. The decision as to which of SRS or PUSCH to overwrite may be configured by eNB. If eNB determines that data is more important, then the eNB may overwrite the TA for SRS. Alternatively, if SRS sounding is determined to be more important, then the eNB may override PUSCH.

As described above, whenever PUSCH/PUCCH and SRS are transmitted from the same subframe and have different TA configurations (as with option 1 above), the TA for one may be overwritten and only one TA may be applied for the whole subframe. When PUSCH/PUCCH has priority and SRS TA gets overwritten, there will be impact on the SRS channel orthogonality with other SRS. eNB can perform further filtering or weighting of such SRS channel measurements.

When SRS has priority, PUSCH/PUCCH may have exhibit some signal loss. For PUSCH, eNB can modify the outer loop to account for the possible performance loss in these affected subframes. For CoMP, where eNB can exchange information of the TA values and TA overwrite options, eNB can apply additional processing to account for the different TA shift from this user, for example, different FFT starting point when PUSCH is shifted in time with respect to other users channels. A relatively better way is to align the timing from difference cells, and to choose channel configurations to minimize such TA mismatches.

In a second option “Option 2,” SRS is transmitted based on the timing of the SRS and different TA are transmitted within a single subframe.

In a third option “Option 3,” SRS is transmitted based on the SRS timing, but the SRS is never transmitted together with PUSCH/PUCCH within the same subframe. This may be achieved by dropping some channels and/or by scheduling.

As described above, in “Option 2,” different TAs with the same subframe may be permitted. Herein, PUSCH/PUCCH and SRS will apply their own timing.

In this case and as is configured by the eNB, every channel has its own timing and within a SF, there is timing shift between the PUSCH/PUCCH and SRS transmission. At the receiver side, both PUSCH and SRS channels are aligned with other users signals. When PUSCH/PUCCH and SRS apply different TA, the overlapping parts can be treated differently. For example, in one case, SRS channel always has priority and the overlapping PUSCH parts may be erased. This is because PUSCH has much longer duration while SRS only occupies one symbol. In another case, PUSCH channel has priority and the overlapping SRS will be erased. Alternatively, a shortened SRS channel can be designed, where instead of transmitting a repeated SRS sequence, only half of it is transmitted.

With Option 3, both PUSCH/PUCCH and SRS may be transmitted according to their own timing, but they are never transmitted on the same subframe (as a result the PUSCH/PUCCH and SRS never collide in the same subframe). Whenever PUSCH/PUCCH and SRS TA differs, or difference exceeding certain value, then drop SRS and transmit the full PUSCH/PUCCH whenever SRS and PUSCH/PUCCH they collide on the same subframe. Whenever there is no collision between the PUSCH/PUCCH and SRS, each is transmitted using its own TA.

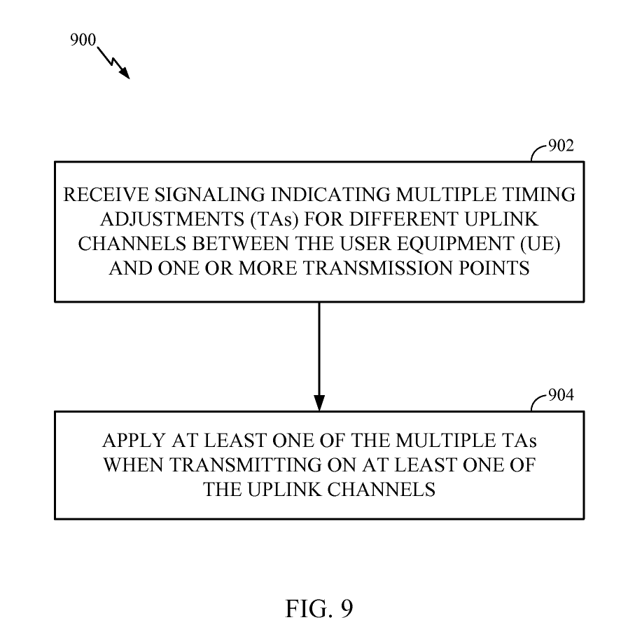

FIG. 9 illustrates example operations 900 that may be performed, for example, by a user equipment (UE). The operations 900 begin, at 902, by receiving signaling indicating multiple timing adjustments (TAs) for different uplink channels between the user equipment (UE) and one or more transmission points. At 904, at least one of the multiple TAs when transmitting on at least one of the uplink channels is applied.

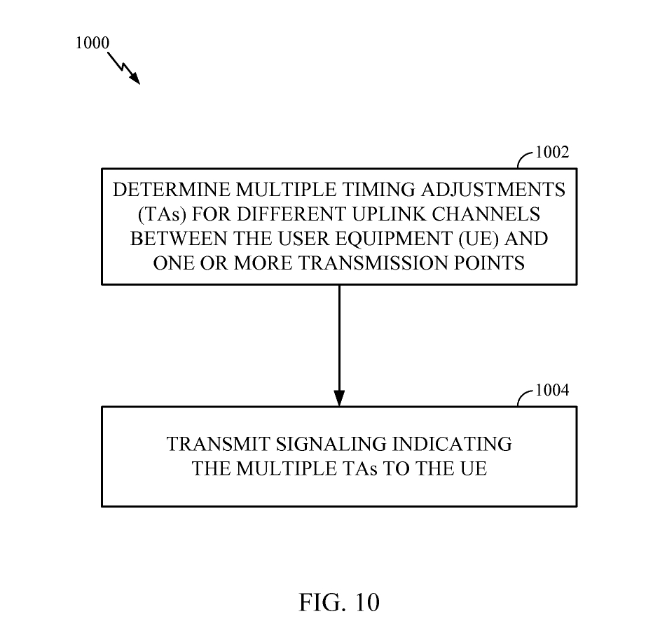

FIG. 10 illustrates example operations 1000 that may be performed, for example, by a base station (e.g., eNB or other type transmission point). The operations 1000 begin, at 1002, by determining multiple timing adjustments (TAs) for different uplink channels between the user equipment (UE) and one or more transmission points. At 1004, signaling indicating the multiple timing adjustments (TAs) to the UE is transmitted.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits and algorithm steps described in connection with the disclosure herein may be implemented as electronic hardware, computer software, or combinations of both. To clearly illustrate this interchangeability of hardware and software, various illustrative components, blocks, modules, circuits and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal Generally, where there are operations illustrated in Figures, those operations may have corresponding counterpart means-plus-function components with similar numbering.

In one or more exemplary designs, the functions described may be implemented in hardware, software, firmware or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communications by a user equipment (UE), comprising:
receiving signaling indicating multiple timing adjustments (TAs) for different uplink channels between the user equipment (UE) and one or more transmission points; and
applying at least one of the multiple TAs when transmitting on at least one of the uplink channels.

2. The method of claim 1, wherein:
the multiple TAs comprise TAs for different channels of different cells.

3. The method of claim 1, wherein the applying comprises:
applying at least two different TAs within the same subframe for different channels.

4. The method of claim 1, wherein the applying comprises:
applying a single one of the multiple TAs when transmitting different channels intended for different transmission points within the same subframe.

5. The method of claim 4, wherein:
the different uplink channels comprise at least a sounding reference signal (SRS) channel and at least one of a physical uplink shared channel (PUSCH) or physical uplink control channel (PUCCH).

6. The method of claim 5, wherein applying a single one of the multiple TAs comprises applying a TA for the SRS channel when transmitting at least one of the PUSCH or PUCCH.

7. The method of claim 5, wherein applying a single one of the multiple TAs comprises applying a TA for at least one of the PUSCH or PUCCH when transmitting the SRS channel.

8. The method of claim 1, wherein the UE receives different TAs for different channels on different subframes.

9. The method of claim 1, further comprising:
determining if different TAs for at least two uplink channels to be transmitted in a common subframe differ by a threshold amount; and
if so, refraining from transmitting one of the at least two uplink channels in the common subframe.

10. The method of claim 9, wherein the UE refrains from transmitting SRS in a common subframe and transmits at least one of a physical uplink shared channel (PUSCH) or physical uplink control channel (PUCCH).

11. The method of claim 1, further comprising:
determining if different TAs for a sounding reference signal (SRS) channel and physical uplink shared channel (PUSCH) to be transmitted in a common subframe differ by a threshold amount; and
if so, erasing at least a portion of one of the SRS channel or the PUSCH.

12. The method of claim 11, further comprising receiving signaling indicating whether to erase at least a portion of the SRS channel or the PUSCH.

13. A method for wireless communications by a base station, comprising:
determining multiple timing adjustments (TAs) for different uplink channels between the user equipment (UE) and one or more transmission points; and
transmitting signaling indicating the multiple timing adjustments (TAs) to the UE.

14. The method of claim 13, wherein:
the multiple TAs comprise TAs for different channels of different cells.

15. The method of claim 14, wherein:
the different uplink channels comprise at least a sounding reference signal (SRS) channel and at least one of a physical uplink shared channel (PUSCH) or physical uplink control channel (PUCCH).

16. The method of claim 13, wherein the TAs comprise different TAs for different channels on different subframes.

17. The method of claim 16, wherein:
the different uplink channels comprise at least a sounding reference signal (SRS) channel and at least one of a physical uplink shared channel (PUSCH) or physical uplink control channel (PUCCH).

18. The method of claim 17, wherein the UE applies a single one of the multiple TAs when transmitting both SRS and at least one of the PUSCH or PUCCH.

19. The method of claim 18, further comprising:
processing received signals in a manner that accounts for the UE applying a single one of the multiple TAs.

20. The method of claim 19, further comprising:
transmitting signaling to the UE indicating whether the UE should erase a portion of a sounding reference signal (SRS) channel or a portion of a physical uplink shared channel (PUSCH) if the UE has been provided different TAs for the SRS channel and PUSCH to be transmitted in a common subframe.

21. An apparatus for wireless communications, comprising:
means for receiving signaling indicating multiple timing adjustments (TAs) for different uplink channels between the user equipment (UE) and one or more transmission points; and
means for applying at least one of the multiple TAs when transmitting on at least one of the uplink channels.

22. The apparatus of claim 22, wherein:
the multiple TAs comprise TAs for different channels of different cells.

23. The apparatus of claim 21, wherein the applying comprises:
applying at least two different TAs within the same subframe for different channels.

24. The apparatus of claim 21, wherein the applying comprises:
applying a single one of the multiple TAs when transmitting different channels intended for different transmission points within the same subframe.

25. The apparatus of claim 24, wherein:
the different uplink channels comprise at least a sounding reference signal (SRS) channel and at least one of a physical uplink shared channel (PUSCH) or physical uplink control channel (PUCCH).

26. The apparatus of claim 25, wherein applying a single one of the multiple TAs comprises applying a TA for the SRS channel when transmitting at least one of the PUSCH or PUCCH.

27. The apparatus of claim 25, wherein applying a single one of the multiple TAs comprises applying a TA for at least one of the PUSCH or PUCCH when transmitting the SRS channel.

28. The apparatus of claim 21, wherein the UE receives different TAs for different channels on different subframes.

29. The apparatus of claim 21, further comprising:
means for determining if different TAs for at least two uplink channels to be transmitted in a common subframe differ by a threshold amount; and
means for, if so, refraining from transmitting one of the at least two uplink channels in the common subframe.

30. The apparatus of claim 29, wherein the UE refrains from transmitting SRS in a common subframe and transmits at least one of a physical uplink shared channel (PUSCH) or physical uplink control channel (PUCCH).

31. The apparatus of claim 21, further comprising:
means for determining if different TAs for a sounding reference signal (SRS) channel and physical uplink shared channel (PUSCH) to be transmitted in a common subframe differ by a threshold amount; and
means for, if so, erasing at least a portion of one of the SRS channel or the PUSCH.

32. The method of claim 31, further comprising means for receiving signaling indicating whether to erase at least a portion of the SRS channel or the PUSCH.

33. An apparatus for wireless communications, comprising:
means for determining multiple timing adjustments (TAs) for different uplink channels between the user equipment (UE) and one or more transmission points; and
means for transmitting signaling indicating the multiple timing adjustments (TAs) to the UE.

34. The apparatus of claim 33, wherein:
the multiple TAs comprise TAs for different channels of different cells.

35. The apparatus of claim 34, wherein:
the different uplink channels comprise at least a sounding reference signal (SRS) channel and at least one of a physical uplink shared channel (PUSCH) or physical uplink control channel (PUCCH).

36. The apparatus of claim 33, wherein the TAs comprise different TAs for different channels on different subframes.

37. The apparatus of claim 36, wherein:
the different uplink channels comprise at least a sounding reference signal (SRS) channel and at least one of a physical uplink shared channel (PUSCH) or physical uplink control channel (PUCCH).

38. The apparatus of claim 37, wherein the UE applies a single one of the multiple TAs when transmitting both SRS and at least one of the PUSCH or PUCCH.

39. The apparatus of claim 38, further comprising:
means for processing received signals in a manner that accounts for the UE applying a single one of the multiple TAs.

40. The apparatus of claim 39, further comprising:
means for transmitting signaling to the UE indicating whether the UE should erase a portion of a sounding reference signal (SRS) channel or a portion of a physical uplink shared channel (PUSCH) if the UE has been provided different TAs for the SRS channel and PUSCH to be transmitted in a common subframe.

41. An apparatus for wireless communication, comprising:
at least one processor configured to receive signaling indicating multiple timing adjustments (TAs) for different uplink channels between the user equipment (UE) and one or more transmission points, and apply at least one of the multiple TAs when transmitting on at least one of the uplink channels; and
a memory coupled with the at least one processor.

42. An apparatus for wireless communication, comprising:
at least one processor configured to determine multiple timing adjustments (TAs) for different uplink channels between the user equipment (UE) and one or more transmission points, and transmit signaling indicating the multiple timing adjustments (TAs) to the UE; and
a memory coupled with the at least one processor.

43. A program product comprising a computer readable medium having instructions stored thereon, the instructions generally executable by one or more processors for:
receiving signaling indicating multiple timing adjustments (TAs) for different uplink channels between the user equipment (UE) and one or more transmission points; and
applying at least one of the multiple TAs when transmitting on at least one of the uplink channels.

44. A program product comprising a computer readable medium having instructions stored thereon, the instructions generally executable by one or more processors for:
determining multiple timing adjustments (TAs) for different uplink channels between the user equipment (UE) and one or more transmission points; and
transmitting signaling indicating the multiple timing adjustments (TAs) to the UE.
